(19) United States
(12) Patent Application Publication
(10) Pub. No.: US 2009/0039048 A1
(43) Pub. Date: Feb. 12, 2009

(54) Venting System and the Use Thereof

(76) Inventors: Linsheng W. Tien, Irvine, CA (US); Kevin Tien, Irvine, CA (US)

Correspondence Address: WPAT, PC;INTELLECTUAL PROPERTY ATTORNEYS, 2030 MAIN STREET, SUITE 1300, IRVINE, CA, 92614, US

(21) Appl. No.: 12/187,365

(22) Filed: Aug. 6, 2008

Related U.S. Application Data
(63) Continuation of application No. 60/954,313, filed on Aug. 6, 2007.

(51) Int. Cl. A61J 9/00; B65D 25/40

(52) U.S. Cl. 215/11.5; 222/566

(57) ABSTRACT

A venting system using ePTFE as a venting membrane in applications such as nursing bottles and eye drop dispensers. The venting system allows inflow of gas to equalize pressure, when liquid is dispensed from a sealed container. The venting system does not allow passage of liquid, and does not allow passage of bacteria and virus. A restrictor can be used in the alternative, or in combination with, the ePTFE membrane.

### CROSS-REFERENCE TO RELATED APPLICATIONS

This application claims priority to U.S. Provisional Pat. No. 60/954,313, filed on Aug. 6, 2007, now pending, which is hereby incorporated by reference in its entirety.

Although incorporated by reference in its entirety, no arguments or disclaimers made in the provisional application apply to this divisional application. Any disclaimer that may have occurred during the prosecution of the above-referenced application(s) is hereby expressly rescinded. Consequently, the Patent Office is asked to review the new set of claims in view of all of the prior art of record and any search that the Office deems appropriate.

### BACKGROUND OF THE INVENTION

(1) Field of the Invention

The field of the invention is gas venting systems for nursing bottles and drug delivery dispensers.

(2) Description of Related Art

Nursing bottles for infants are known to require some type of venting mechanism so that when an infant suck milk out of the bottle, air can be introduced into the bottle through the venting mechanism to equalize pressure. Without such venting mechanism, a vacuum created by the sucking will make it difficult for the infant to suck milk out of the bottle. Other disadvantages include:
1. Difficulty in sucking the bottle makes the infant tired, and discourages the baby from drinking adequate milk.
2. The infant ends up ingesting large amount of air bubbles, which creates gas build-up in the gastro-intestinal tract, and causes excess burping, regurgitation, and stomach pain.
3. Difficulty in sucking the milk out causes the infant to use excessive sucking force, which can affect teeth growth and configuration.
4. Infants often fall asleep when he's tired from sucking the bottle. Vacuum pressure in the bottle sucking in air can create a sudden noise that wakes the infant from his sleep.

Generally known methods of venting include using a one-way diaphragm, as described in U.S. Pat. No. 5,692,627. Other methods are also known, for example, see U.S. Pat. Nos. 3,718,140; 4,821,896; 5,692,627; 2,545,350; 7,150,370; 4,723,668; 5,284,261; all of which are herein incorporated by reference in their entirety. Despite numerous desirable properties, however, there remains to be unmet needs in the market for a nursing bottle that is relatively leak-proof.

Dispensers for eye drop solutions are easily contaminated by the “suck back” action when a dispenser dispenses the eye drop (by squeezing the soft bottle and then releasing it.). Known solution includes adding high concentrations of harmful preservatives in the formulation. Other known methods include using single-dose units (which increases production cost), or use positive pressure dispensers (filled with high pressure Nitrogen) to prevent “suck back” action which often carries bacteria. There continues to be a need for a better dispenser to solve these stated problems.

### BRIEF SUMMARY OF THE INVENTION

### Nursing Bottle

Among the many different possibilities contemplated, the contemplated nursing bottle has a venting mechanism using ePTFE technology, available from W.L. Gore & Associates (Tel. 1.800.637.4449, Email packvent@wlgore.com, Internet address: http://www.gore.com). Additional information about the ePTFE membrane can be found here:

http://www.gore.com/en_xx/products/venting/packaging/packaging_vents_faq.html
http://www.gore.com/en_xx/products/venting/packaging/forms/molded_components.html
http://www.gore.com/en_xx/products/venting/packaging/eptfe_membrane.html

When integrated into a packaging design, expanded PTFE (ePTFE) allows for the release of gases without letting liquid penetrate the venting membrane. W.L. Gore & Associates has a GORE™ Packaging Vent useful for containers where it is necessary to relieve the pressurization effects of gas scavenging, off-gassing, or environmental changes on a container, bottle, or package. Thus far, however, there has been no suggestions, teachings, for using such ePTFE vent for nursing bottles.

The contemplated nursing bottle has a venting system located anywhere on the bottle (bottom, near bottom, middle, top of bottle, etc.) The system contains an ePTFE membrane, the membrane may be user-changeable, and the membrane may be provided as disposable units. The system can be integrated in the bottle by various ways, such as screw-in, snap-in, fixed in.

Optionally, the system can include a restrictor in addition to the ePTFE membrane, such as those used in eye drop dispensers to restrict outflow of eye drop solution, to control the droplet size and to prevent leaking of the solution out of the dispenser when the dispenser is placed in an upward position. With the restrictor in place, eye drop will come out only when the user squeezes the dispenser. Examples of restrictors can be found in U.S. Pat. Nos. 6,341,718; 5,044,394; 5,048,723, and WO/1996/030689, all of which are herein incorporated by reference.

Depending on the size of bottle and volume of solution to dispense in each outflow, the restrictor opening diameter is preferred to be from 0.005 inch to 0.012 inch.

Also, some embodiments can include nursing bottles with the restrictor, without using the ePTFE membrane.

### Eye Drop Dispenser

Preferred embodiments is to use the venting mechanism as described above (air-vent) in an eye drop dispenser that can let air flow in, and will prevent liquid from leak out. The device also prevents entry of bacteria into the dispenser due to characteristic properties of ePTFE membrane (<0.22 um pore size to filter out bacteria and virus, <0.45 um pore size to filter out bacteria). The ePTFE membrane will be of pharmaceutical grade. FIG. 2 shows one embodiment of the contemplated eye drop dispenser.

### Other Applications:

1. Food/drink packaging and/or dispenser—juice, drink, water bottle (especially for babies).
2. Pharmaceuticals and/or cosmetics dispenser—bottle (e.g., dispenser for eye, nasal application), IV bottles, and any container where suck-back of bacteria or dirt is unwanted, and any drug delivery system that needs to solve a “negative pressure” problem when dispensing drugs.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a perspective view of a first embodiment of the venting system in use with a nursing bottle.

FIG. 2 is a perspective view of the venting system in use with a drug dispenser.

FIG. 3 is a side view of two embodiments of drug delivery dispensers.

FIG. 4 is a perspective view of an embodiment of mold component venting systems.

### DETAILED DESCRIPTION OF THE INVENTION

The invention and its various embodiments can now be better understood by turning to the following detailed description of the preferred embodiments, which are presented as illustrated examples of the invention defined in the claims. It is expressly understood that the invention as defined by the claims may be broader than the illustrated embodiments described below. It should also be noted that the drawings are in simplified form and are not to precise scale. In reference to the disclosure herein, for purposes of convenience and clarity only, directional terms, such as, top, bottom, left, right, up, down, over, above, below, beneath, rear, front, distal, and proximal are used with respect to the accompanying drawings. Such directional terms should not be construed to limit the scope of the invention in any manner.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed herein even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

### Nursing Bottle

Among the many different possibilities contemplated, the contemplated nursing bottle has a venting mechanism using ePTFE technology, available from W.L. Gore & Associates (Tel. 1.800.637.4449, Email packvent@wlgore.com, Internet address: http://www.gore.com). Contemplated nursing bottle may use a packaging vents/molded components.

The following information is provided by W.L. Gore & Associates on its website. GORE™ Packaging Vents are constructed out of expanded polytetrafluoroethylene (ePTFE). This material prevents liquid penetration, while allowing airflow and equalizing pressure. When splashed by a viscous liquid, the membrane will quickly recover its venting capability. GORE™ Membranes offer varying airflow rates and resistance to wetting by low surface tension liquids.

Rapidly stretching PTFE under the right conditions creates a very strong, microporous material. The result, known ePTFE, exhibits an amazing array of properties:
Strength (high strength-to-weight ratio)
Chemical inertness
Biocompatibility
High thermal resistance
High chemical resistance in harsh environments
Low flammability
Low coefficient of friction
Low dielectric constant
Low water adsorption
Good weathering properties

When integrated into a package design, ePTFE allows for the release of gases without letting liquid penetrate the venting membrane. When liquid penetrates other porous material, airflow stops. This phenomenon is referred to as “wetting out”. Ordinary membranes that simply allow initial airflow will clog quickly, prohibiting consistent airflow and will often leak—especially when a container is in an upside down position during use. GORE™ Packaging Vents allow consistent airflow, even after liquid contact.

When liquids are sprayed or dispensed, a vacuum is created within a closed system. GORE™ Packaging Vents allow the package to breathe by equalizing pressure. This simple closure vent solution helps to assure that containers maintain their shape and do not leak while liquids are being dispensed.

Typically the optimized choice of a container vent depends on two requirements:
airflow rate
liquid resistance (only for containers with liquid products inside)
   The airflow requirement is defined as the volume of air which must be exchanged between the inside and the outside of a container, in a given amount of time. It can be influence by several factors, including:
gas exchange rate of the container contents
temperature cycles
altitude or other pressure changes

Airflow is measured using a Gurley densometer, which measures the amount of time required to pass 100 cc of air through 1 square inch of material at 0.17 pounds per square inch (12 mbar). Typically this is converted to airflow in liters per hour.

In order for a container vent to perform properly, there must be sufficient airflow AFTER liquid contact. This is the best measure of liquid resistance. Gore's super-resistant ePTFE membranes are designed to offer the best liquid resistance of any commercially available fluoropolymer materials, for the widest range of possible contact fluids. Liquid resistance is strongly influenced by the chemistry of the liquid in the container (see question# 5 below). Typically the liquid resistance is quantified by measurement of the materials water entry pressure (WEP), otherwise known as water breakthrough pressure (WBP). WEP is defined as the amount of pressure necessary to force water through a membrane, normalized for a given area.

Contemplated venting system can be molded components in various sizes fitting a volume range from 0.02-1.00 liter, and simply snap or press-fit into place.

Thus far, however, there has been no suggestions, teachings, for using such ePTFE vent for nursing bottles and drug delivery dispensers.

Referring now to FIG. 1, a nursing bottle is shown with venting system having a ePTFE membrane disposed at the bottom end of the bottle, and a restrictor disposed inside the nipple portion of the bottle. It should be noted that the contemplated nursing bottle can have a venting system located anywhere on the bottle (bottom, near bottom, middle, top of bottle, etc.) The system contains an ePTFE membrane, the membrane may be user-changeable, and the membrane may be provided as disposable units. The system can be integrated in the bottle by various ways, such as screw-in, snap-in, fixed in.

Optionally, contemplated bottle can include a restrictor in the dispensing nipple portion, in addition, or as an alternative, to the ePTFE membrane. The type of restrictor can be those used in eye drop dispensers to restrict outflow of eye drop solution, to control the droplet size and to prevent leaking of the solution out of the dispenser when the dispenser is not placed in an upward position. Typically, with the restrictor in place, eye drop will come out only when the user squeezes the dispenser. Examples of restrictors can be found in U.S. Pat. Nos. 6,341,718; 5,044,394; 5,048,723, and WO/1996/030689, all of which are herein incorporated by reference. Here, the restrictor help regulate flow of liquid out of the bottle.

Depending on the size of bottle and volume of solution to dispense in each outflow, the restrictor opening diameter is preferred to be from 0.005 inch to 0.012 inch.

As mentioned earlier, some embodiments can include nursing bottles with the restrictor, without using the ePTFE membrane.

FIG. 1 shows an embodiment where a nursing bottle has an ePTFE membrane at its bottom, the ePTFE is of food grade and has specification necessary to allow sufficient air flow considering the amount of milk being dispensed. One skilled in the art would immediately recognize that the shape, size, and configuration of the venting system on the nursing bottle can be varied. Preferably the venting system is located at positions not blocked by the hand that hold the bottle. In another embodiment, the venting system can be a detachable bottom lid. For example, it is a lid that screws onto the bottom of the bottle. Detaching the lid from the bottle give one direct access to the inside of the bottle. The lid may have a diameter as wide as the diameter of the bottle. The lid has an ePTFE membrane for venting purposes.

### Drug Dispenser

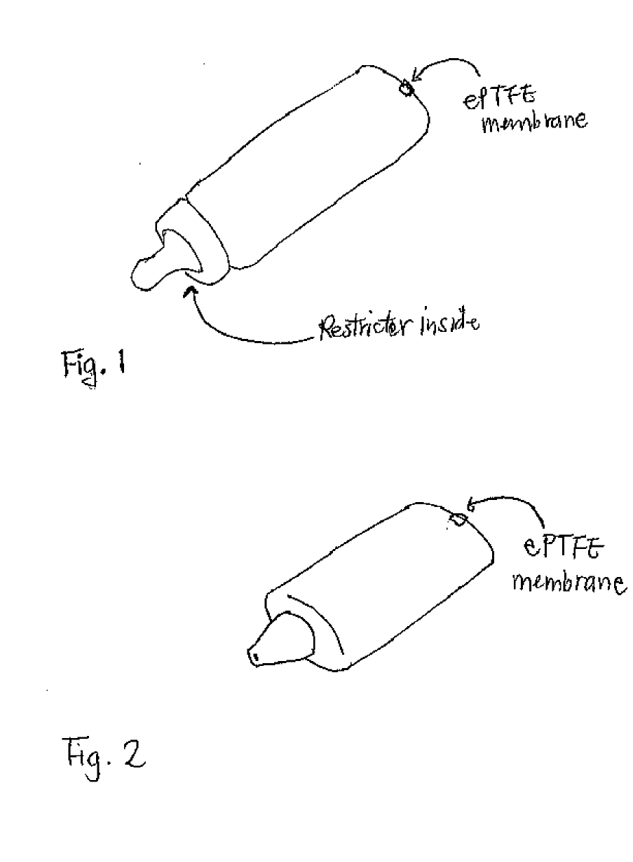

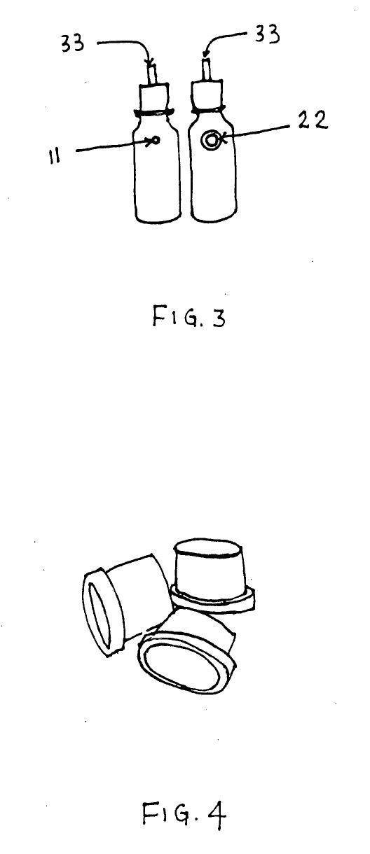

Preferred embodiments is to use the venting mechanism as described above (air-vent) in an eye drop dispenser that can let air flow in, and will prevent liquid from leaking out. Although allowing inflow of air, the venting system prevents entry of bacteria into the dispenser due to characteristic properties of ePTFE membrane (pore size <0.22 um is effective for filtering out bacteria and virus, pore size <0.45 um will filter out bacteria only). Preferred ePTFE membrane will be of pharmaceutical grade. FIG. 2 shows one embodiment of the contemplated eye drop dispenser where the venting system is disposed near the bottom end of the dispenser. When disposed at the bottom end, it lets air flow into the dispenser when the user is dispensing eye drop, squeezing the dispenser while the dispenser is in an up-side-down position.

In FIG. 3, two dispensers are disclosed side-by-side. The dispenser on the left has a rather small venting system 11 disposed on the shoulder portion of the dispenser. Each of both dispensers has a liquid-holding body, a dispensing tip coupled to said liquid-holding body, and a venting system disposed on the drug dispenser wherein the venting system has an ePTFE membrane. As shown in FIG. 3, the dispenser on the right has a relatively larger venting system 22 disposed on the shoulder portion of the dispenser. Both venting systems are contemplated venting system as disclosed above. Both dispensers have dispensing tips with filter tips.

In one preferred embodiment, the filter tip 33 has a pore size of 0.45 um or less. In a more preferred embodiment, the filter tip has a pore size of 0.22 um or less. As an example, dispenser tip can use Millipore 4 mm syringe filters. Also, Nalgene 4 mm 0.2 um “Nylon” filter can also be used. The choice in pore size affects the function of the venting system. In preferred systems, the filter tip filters bacteria and virus out of the liquid-holding body, thus the liquid-holding body can hold solutions that are preservative-free.

Preferred filter tip is made of material that absorbs preservatives in a liquid that passes through said filter tip. For example, such material can be selected from PVDF, PTFE, Nylon, PES, and GHP.

Although 0.22 um or less pore size is preferred in the tip size, when the filter is wet, it does not allow inflow of gas, which causes negative pressure build-up in the bottle after dispensing. Preferred venting system allows inflow of gas to resolve the problem of negative pressure build-up. As a result, preservatives are not needed in the eye drop inside of the dispenser.

In one preferred venting system for eye drop dispenser, Gore-supplied D 3 and D10 model vent is particularly desired. While both are desirous for drug dispeners, D10 or bigger size vents are particularly good for nursing bottles.

| | Part Number | | | | |
|---|---|---|---|---|---|
| | D3 | D10 | D15 | D17 | D38 |
| Part Diameter | 3 mm | 10 mm | 15 mm | 17 mm | 38 mm |
| Water Entry | >0.5 bar | >0.4 bar | >0.5 bar | >0.5 bar | >0.5 bar |
| Pressure (WEP) | | | | | |
| Typical Airflow | 20 ml/h | 0.22 l/h | 1.1-2.6 l/h | 1.3-3.6 l/h | 10-30 l/h |
| | at 50 mbar | at 12 mbar | at 12 mbar | at 12 mbar | at 12 mbar |
| Recommended | 0.02-0.2 liters | 0.2-2 liters | 2-30 liters | 5-60 liters | 60-1,500 |
| Container Volume | | | | | liters |

Optionally, preferred tip uses tip materials that can absorb the preservatives, if preservatives are used in the eye drop solution. Such materials includes PVDF (poly vinyl alcohol), such filters can have be made into a filter with 5-50 um pore size. Preferred filter can absorb preservative BAK (benzalkonium chloride—the most popular and effective preservative used in eye drops, but damaging to cells of eye, and prone to attach to contact lenses). This way, preservative in the dispenser is filtered through the tip filter before reaching a user's eye. In combination, a venting system will allow inflow of gas, will preventing bacteria and virus from entering into the dispenser with the inflow of gas.

Optionally, the dispensing tip can be made of anti-microbial tip, or other material that absorbs preservatives. Also, the tip can be an aerosol spray tip, or a pump spray tip.

### Other Applications:

Contemplated venting system can be used in food/drink packaging and/or dispenser—juice, drink, water bottle (especially for babies). Also, contemplated venting system can be used for pharmaceuticals and/or cosmetics dispenser—bottle (e.g., dispenser for eye, nasal application), IV bottles, and any container where suck-back of bacteria is unwanted, and any drug delivery system that needs to solve a “negative pressure” problem when dispensing drugs.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention. The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

Thus, specific embodiments and applications of Venting System have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what essentially incorporates the essential idea of the invention. In addition, where the specification and claims refer to at least one of something selected from the group consisting of A, B, C . . . and N, the text should be interpreted as requiring only one element from the group, not A plus N, or B plus N, etc.

What is claimed is:

1. A drug dispenser comprising:
a liquid-holding body;
a dispensing tip coupled to said liquid-holding body; and
a venting system disposed on the drug dispenser wherein the venting system has an ePTFE membrane.

2. The drug dispenser of claim 1, wherein the dispensing tip has a filter tip.

3. The drug dispenser of claim 2, wherein the filter tip has a pore size of 0.45 um or less.

4. The drug dispenser of claim 3, wherein the filter tip has a pore size of 0.22 um or less.

5. The drug dispenser of claim 4, wherein said filter tip filters bacteria and virus out of the liquid-holding body, and wherein said liquid-holding body holds preservative-free solutions.

6. The drug dispenser of claim 2, wherein the filter tip is made of material that absorbs preservatives in a liquid that passes through said filter tip, and said material is at least one selected from a group consisting of PVDF, PTFE, Nylon, PES, and GHP.

7. The drug dispenser of claim 2, wherein the dispensing tip is selected from a group consisting of an aerosol spray tip, and pump spray tip.

8. A nursing bottle, comprising:
a bottle body;
a nipple portion detachably coupled to a top end of the bottle body,
a venting system disposed on the nursing bottle wherein the venting system has an ePTFE membrane.

9. The nursing bottle of claim 9 further comprising a restrictor coupled to the nipple portion.
